(19) United States
(12) Patent Application Publication
(10) Pub. No.: US 2017/0036616 A1
(43) Pub. Date: Feb. 9, 2017

(54) MONITOR MOUNT

(71) Applicant: JONG HO LIM, Seoul (KR)

(72) Inventor: JONG HO LIM, Seoul (KR)

(21) Appl. No.: 14/820,569

(22) Filed: Aug. 7, 2015

(51) Int. Cl. B60R 11/02

(52) U.S. Cl. CPC B60R 11/0229; B60R 2011/0059

(57) ABSTRACT

According to an embodiment of the present disclosure, a monitor mount comprises a headrest fixing part comprising a clamp holding a headrest pole, and a bracket to which the clamp is slidably coupled and a mount body coupled with the headrest fixing part, wherein a monitor is coupled with the mount body to be tilted with respect to the mount body.

### TECHNICAL FIELD

Embodiments of the present disclosure concern monitor mounts, and more specifically, to monitor mounts installed on a seat of an automobile.

Various types of monitor mounts are coming to the market. A monitor mount may mount a video player, game player, global positioning system (CPS) device, or other displaying devices to a seat in an automobile. Such a monitor mount is primarily installed on the backside of a seat in the car. However, as the height or shape of the seat varies depending on the car, different types of monitor mounts need to be used. Further, conventional types of monitor mounts remain are installed, fastened to the seat, rendering it difficult to tilt the monitor to fit the user's view. Accordingly, a need exists for a monitor mount that may be used to be compatible with various types of seats and that may be tilted to fit the user's view angle.

### SUMMARY

According to an embodiment of the present disclosure, a monitor mount comprises a headrest fixing part comprising a clamp holding a headrest pole, and a bracket to which the clamp is slidably coupled and a mount body coupled with the headrest fixing part, wherein a monitor is coupled with the mount body to be tilted with respect to the mount body.

The clamp may include a sliding part slidably coupled to a guide rail formed in the bracket and a covering part pivotally coupled to the sliding part.

The sliding part and the covering part, respectively, may have curved parts, the headrest pole positioned between the curved parts.

The sliding part and the covering part may be fastened to each other by a bolt, with the headrest pole positioned therebetween.

The monitor mount may further comprise a pan of covers coupled to each other to cover the headrest fixing part.

The monitor mount may further comprise a spacer provided the headrest fixing part and the mount body.

A part of the mount body which is coupled with the headrest fixing part may be positioned at one of various heights.

The monitor may be tilted by way of a tilting mechanism with respect to the mount body.

The tilting mechanism may comprise a shaft attached to the mount body, a cam washer attached to an end portion of the shaft and having a cut, and a stand connected with the cam washer is through a hole of the stand and having a claw at a position corresponding to the cut, wherein a width of the claw is smaller than a width of the cut, and wherein the stand is attached to the monitor.

The monitor mount may further comprise a nut coupled to the end portion of the shaft and a coil spring between the nut and the stand.

One of the cam washer and the stand may include at least one hole, and the other of the cam washer and the stand may include at least one protrusion at a position fitted into the at least one hole.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is an exploded perspective view illustrating a monitor mount according to an embodiment of the present disclosure;

FIG. 2 is a perspective view illustrating a monitor mount when assembled, according to an embodiment of the present disclosure;

FIG. 3 is a perspective view illustrating a monitor mount coupled to headrest poles according to an embodiment of the present disclosure;

FIG. 4 is a perspective view illustrating, an example where spacers are provided between a mount body and a headrest fixing part according to an embodiment of the present disclosure;

FIG. 5 illustrates mount bodies of monitor mounts having connected parts of different heights according to embodiments of the present disclosure;

FIG. 6 is a perspective view illustrating a coupling structure between a mount body and a monitor according to an embodiment of the present disclosure; and

FIG. 7 illustrates a tilting mechanism and a mount body and a monitor coupled with each other the tilting mechanism according to an embodiment of the present disclosure.

### DETAILED DESCRIPTION OF EXEMPLARY EMBODIMENTS

Hereinafter, exemplary embodiments of the inventive concept will be described in detail with reference to the accompanying drawings. The inventive concept, however, may be modified in various different ways, and should not be construed as limited to the embodiments set forth herein. The same reference denotations may be used to refer to the same or similar elements throughout the specification and the drawings. As used herein, the singular forms “a,” “an,” and “the” are intended to include the plural forms as well, unless the context clearly indicates otherwise. It will be understood that when an element or layer is referred to as being “on,” “connected to,” “coupled to,” or “adjacent to” another element or layer, it can be directly on, connected, coupled, or adjacent to the other element or layer, or intervening elements or layers may be present.

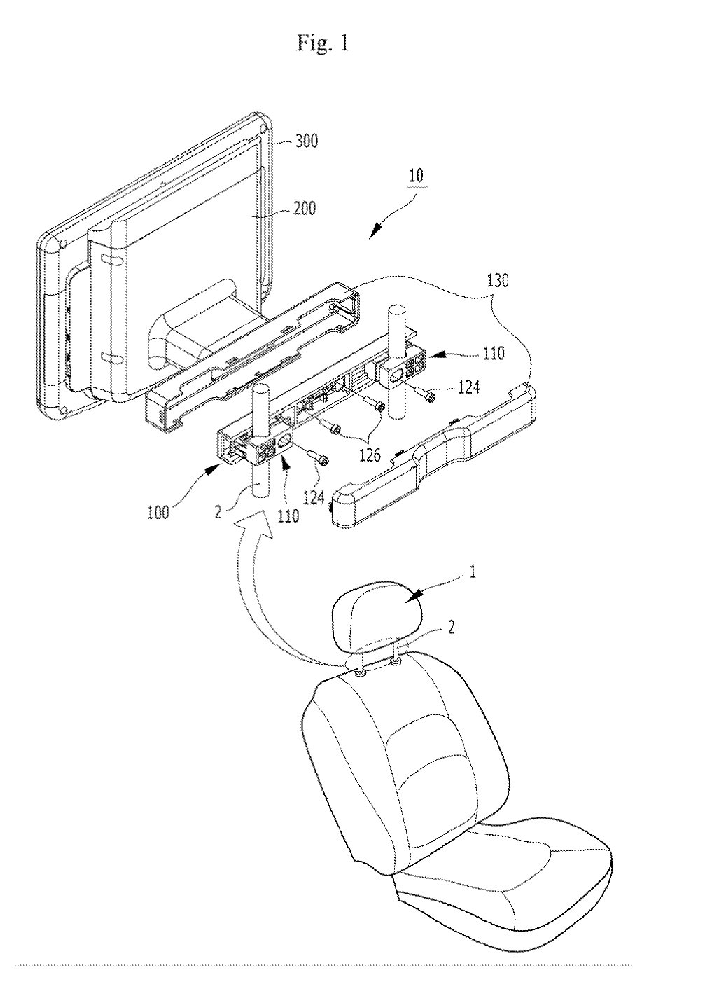

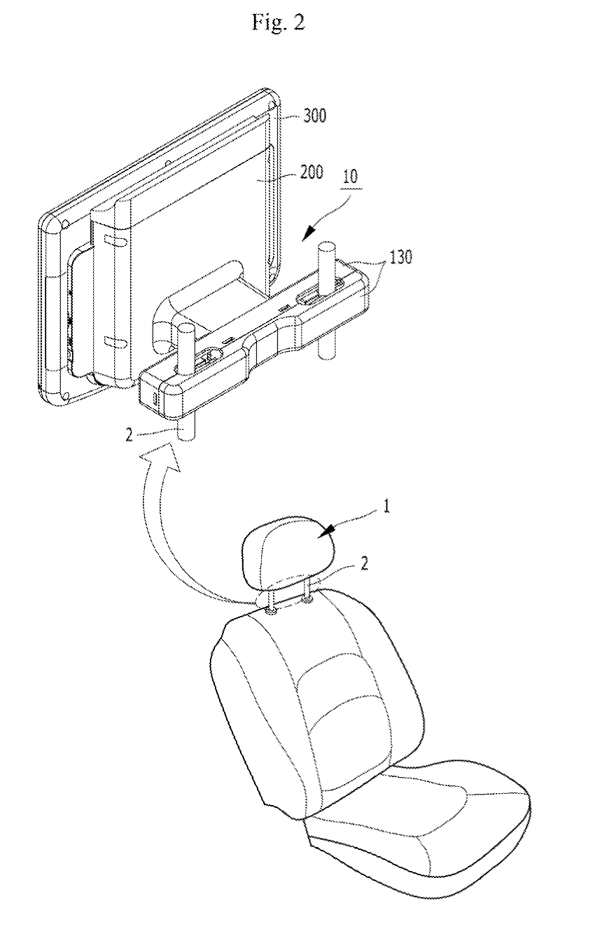

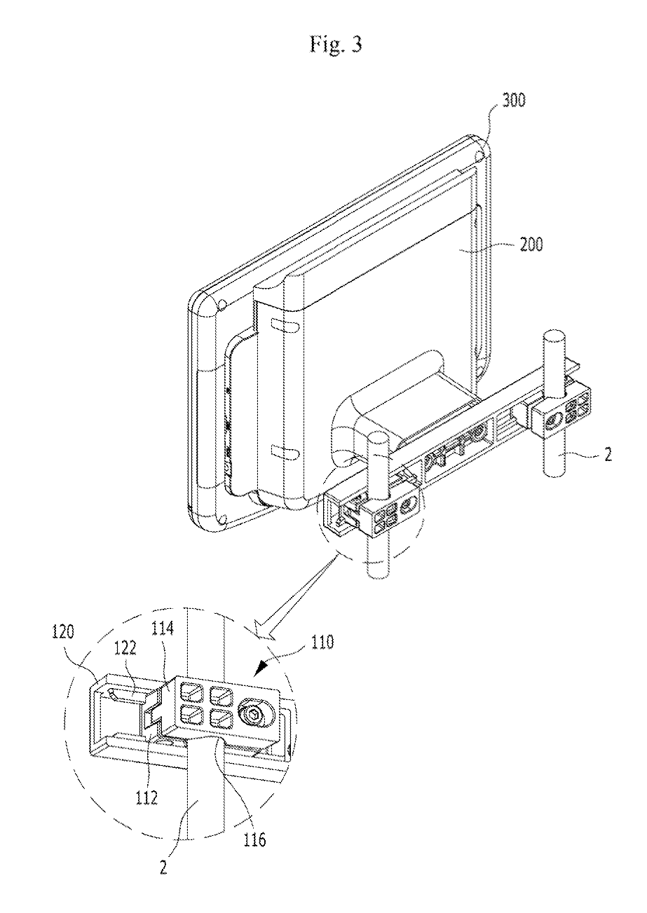

FIG. 1 is an exploded perspective view illustrating a monitor mount according to an embodiment of the present disclosure. FIG. 2 is a perspective view illustrating a monitor moat when assembled, according to an embodiment of the present disclosure. FIG. 3 is a perspective view illustrating a monitor mount coupled to headrest poles according to an embodiment of the present disclosure.

Referring to FIGS. 1 to 3, the monitor mount 10 includes a headrest fixing part 100 and a mount body 200. A monitor 300 may be mounted on the mount body 200.

The headrest fixing part 100 includes a bracket 120 and a pair of clamps 110 that are coupled with the bracket 120 to hold headrest poles 2. The clamps 110 may be slid along a surface of the bracket 120.

Referring to FIG. 3, the clamps 110 are coupled to the headrest poles 2 spaced apart from each other to surround the headrest poles 2. Each clamp 110 may include a sliding part 112 slidably coupled to a guide rail 122 formed in the bracket 120 and a covering part 114 pivotally coupled to the sliding part 112.

As such, each clamp 110 is configured so that its sliding part 112 may be slid on the bracket 120, and thus, as the clamps 110 are moved closer or away from each other, the distance between the clamps 110 may be adjusted. Thus, the distance between the clamps 110 may be adjusted to fit the distance between the headrest poles 2 that varies per automobile type.

The sliding part 112 and the covering part 114 each has a curved part 116 to fit the outer surface of their corresponding headrest pole 2. The covering part 114 may be pivotally opened on an end of the sliding part 112, a corresponding headrest pole 2 may be positioned between the covering part 114 and the sliding part 112, specifically between the respective curved parts 116 of the covering part 114 and the sliding part 112, and the covering part 114 may be then closed, thus allowing the headrest pole 2 to be firmly held by the covering part 114 and the sliding pan 112, with the headrest pole 2 and the bracket 120 tightly contacting each other.

The covering part 114 and the sliding part 112 may be firmly fastened to each other by way of a bolt 114, with the covering part 114 and the sliding part 112 holding the headrest pole 2, thus enabling a more secure coupling.

According to embodiments of the present disclosure, the clamps 110 both may be moved or slid, or one of the clamps 110 may be slid or moved while the other 110 remains at a fixed position.

The mount body 200 is coupled with the headrest fixing part 100 holding the headrest poles 2. The test unit 10 may be mounted towards the rear seats. The headrest fixing pan 100 and the mount body 200 may be coupled with each other via bolts 126 as shown in FIG. 1. However, embodiments of the present disclosure are not limited thereto. For example, a coupling between the headrest fixing part 100 and the town body 200 may be made via any other various means, e.g., by way of a hook and a hooked pan respectively formed in the headrest fixing part 100 and the mount body 200 or vice versa.

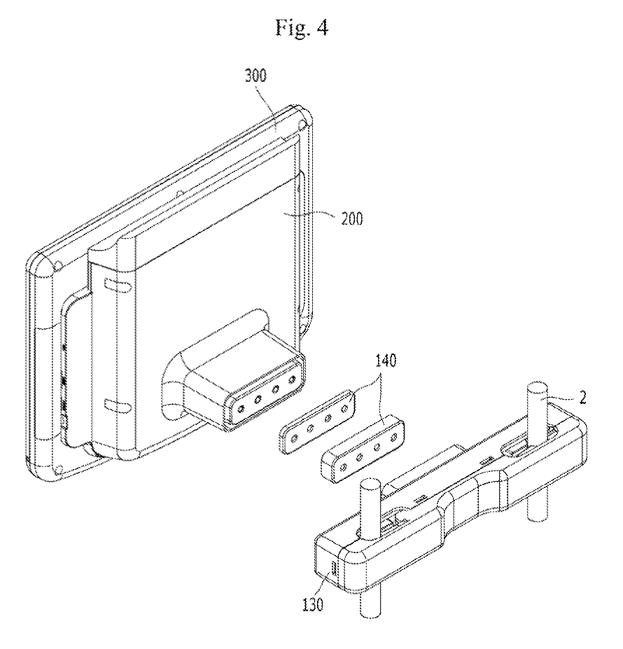

FIG. 4 is a perspective view illustrating an example where spacers are provided between a mount body and a headrest fixing part according to an embodiment of the present disclosure.

Referring to FIG. 4, a spacer 140 may be positioned between the headrest fixing part 100 and the mount body 200. The spacer 140 may space the headrest fixing part 100 apart from the mount body 200 at a predetermined distance or more. Various thicknesses of the spacer 140 may be used according to the thickness of the headrest 1. Accordingly, the spacer 140 may leave the mount body 200 at an optimal position with respect to the headrest 1 of the front seat. For example, there may be used a spacer 140 with a thickness at which the mount body 200 may be brought in tight contact with the headrest 1, thus minimizing vibrations that may be created while the automobile drives. Although two spaces 140 are shown in FIG. 4, the number of spaces 140 is not limited thereto. For example, one or more than two spaces 140 may be provided according to embodiments of the present disclosure.

A pair of covers 130 may be coupled to each other to cover and surround the headrest fixing part 100. The covers 130 may prevent the headrest fixing part 100 from being exposed to the outside. The covers 130 may be coupled with each other, e.g., by press-fitting protrusions formed in one of the covers 130 into holes formed in the other of the covers 130. For example, as shown in FIG. 3, one of the covers 130 may be positioned between the mount body 200 and the headrest fixing part 100, with the headrest fixing part 100 coupled to the headrest poles 2, and the other of the covers 130 may be coupled to the one cover 130, e.g., via bolts 126, to cover the headrest fixing part 100.

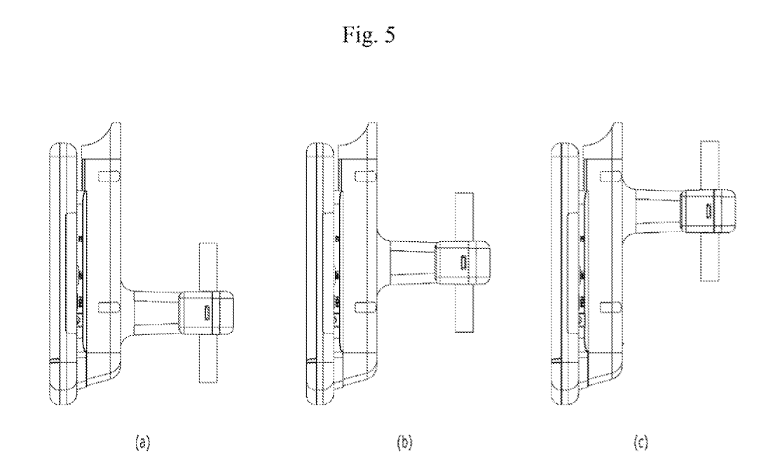

FIG. 5 illustrates mount bodies of monitor mounts having connected parts of different heights according to embodiments of the present disclosure.

According to an embodiment of the present disclosure, the part of the mount body 200, where the headrest fixing part 100 is coupled, (the part of the mount body 200 may be referred to as a “connected part”) may be positioned at various heights on a rear surface of the mount both 200, as shown in FIG. 5. For example, the connected part of the mount body 200 may be formed at a lower side on the rear surface of the mount body 200 as shown in FIG. 5(a), at a middle side on the rear surface of the mount body 200 as shown in FIG. 5(b), or at an tipper side on the rear surface of the mount body 200 as shown in FIG. 5(c). Thus, the mount body 200 with the connected part as shown in FIG. 5 may be selected to fit the height of the passenger who seats on the rear seat. Although the connected part of the mount body 200 is formed at the lower, middle, or upper side of the mount body 200 as shown in FIG. 5, embodiments of the present disclosure are not limited thereto. Alternatively, the connected part of the mount body 200 may be positioned at different heights, e.g., between the lower and middle side of the mount body 200 or between the middle and upper side of the mount body 200, allowing the monitor 300 a different height.

The monitor 300 may be mounted on the mount body 200 coupled with the headrest fixing part 100. The monitor 300 may include, but is not limited to, a television (TV), a digital video disc (DVD) player, a game player, and other electronic device that may display images or videos.

The monitor 300 may be coupled with the mount body 200 to be tilted at a predetermined angle with respect to an end of the mount body 200. Thus, the passenger viewing the monitor 300 may tilt the monitor 300 to tit his/her view angle.

Various types of tilting structures may be used for the monitor 300.

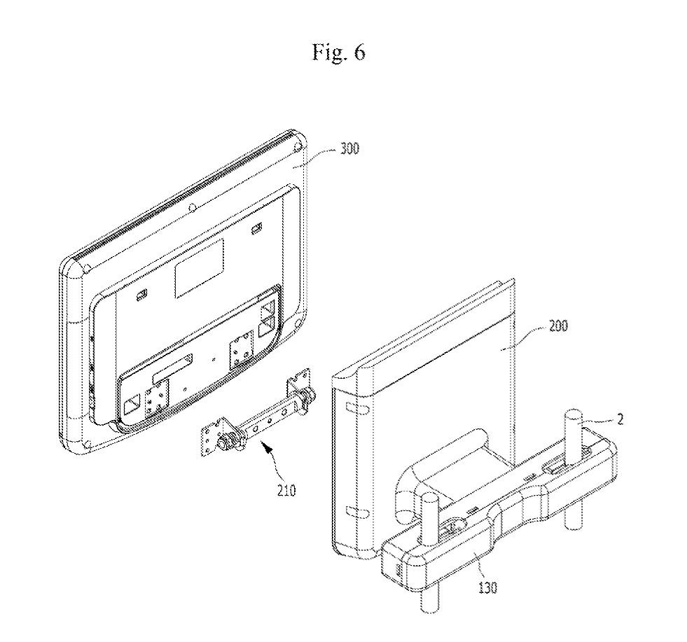

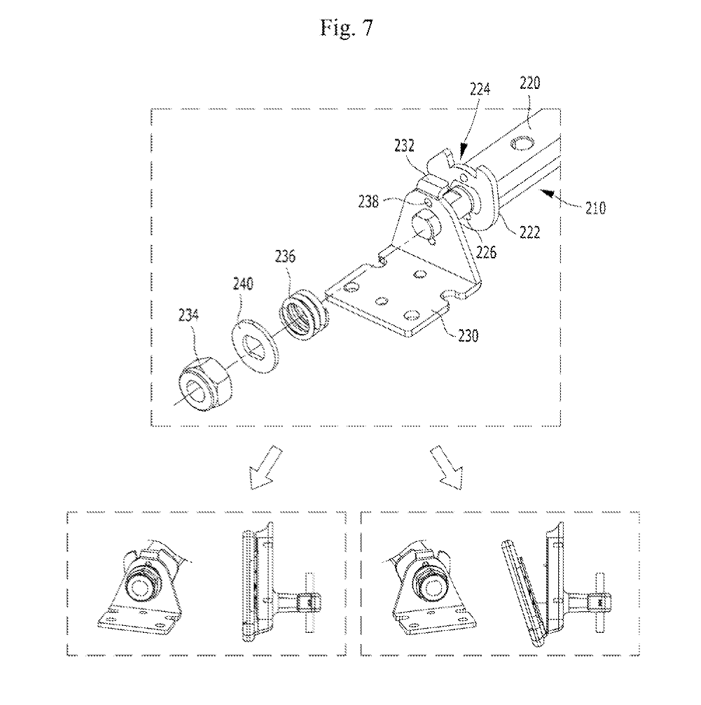

FIG. 6 is a perspective view illustrating a coupling structure between a mount body and a monitor according to an embodiment of the present disclosure. FIG. 7 illustrates a tilting mechanism and a mount body and a monitor coupler with each other the tilting mechanism according to an embodiment of the present disclosure.

Referring to FIGS. 6 and 7, a tilting mechanism 210 maybe formed on the mount body 200 so that the monitor 100 may be tilted or pivoted with respect to the mount body 200.

Referring to FIGS. 6 and 7, the tilting mechanism 210 may include, at an end thereof, a shaft 220 fastened to the mount body 200, a cam washer 222 fastened to an end of the shaft 220 and having a cut 224 on an upper portion thereof, and a stand 230 having a claw 232 on an upper side thereof corresponding to the cut 224 of the cam washer 222.

The stand 230 has a hole through which an end portion of the shaft 220 passes. The end portion of the shaft 220 sequentially passes through the hole of the stand 230, a coil spring 236, a washer 240, and a nut 234. The stand 230 may be tilted up and down, with the end portion of the shaft 220 inserted through the hole of the stand 230. The stand 230 may be attached to a rear surface of the monitor 300.

A width of the claw 232 may be smaller than a width of the cut 224, so that the stand 230 may be tilted up and down while the claw 232 travels within a range of the width of the cut 224, thus enabling the tilting of the monitor 300 to which the tilting mechanism 210 is attached. Accordingly, the angle at which the monitor 300 may correspond to the distance at which the claw 232 moves within the width of the cut 224. In other words, the pivoting angle of the stand 230 or tilting angle of the monitor 300 may be restricted to be within the width of the claw 232.

The structure including the cam washer 222, the stand 230, the coil spring 236, the washer 240, and the nut 234 may bhe formed at either or both ends of the shaft 220.

The coil spring 236 between the nut 234 and the stand 230 enables the stand 230 to be elastically spaced apart from the cap washer 222. The stand 230 may have upper and lower holes 238, and the cam washer 222 may have upper and lower protrusions 226 that may respectively lit into the upper and lower holes 238 of the stand 230. The coil spring 236 may push the stand 230 to the cam washer 222 so that the upper and lower protrusions 226 may be inserted into the upper and lower holes 238 to restrict the movement of the stand 230. When the coil spring 236 is pushed back to the washer 240, the upper and lower protrusions 226 may be escaped from the upper and lower holes 238, so that the stand 230 may be moved with a predetermined range (e.g., the range of the width of the cut 224 with the movement of the claw 232 restricted by the cam washer 222, thus enabling the tilting of the monitor 300.

The washer 240 positioned between the coil spring 236 and the nut 234 may allow the coil spring 236 to remain at a stable position.

Although the upper and lower holes 238 are shown in the drawings, embodiments of the present disclosure are not limited thereto. For example, the holes 238 of the stand 230 may be formed at other positions of the stand 230. For example, the boles 238 may be formed at left and right portions of the stand 230. Likewise, the protrusions 226 may be formed at other positions of the cam washer 222, and for example, the protrusions 226 may be formed at left and right portions of the cam washer 222. Although two holes 238 and two protrusions 226 are shown in the drawings, embodiments of the present disclosure are not limited thereto. Alternatively, three or more holes 238 and three or more protrusions 226 may be formed at different positions than those shown in the drawings. Alternatively, holes 238 may be formed in the cam washer 222, and protrusions 226 may be formed in the stand 230.

According to embodiments of the present disclosure, the clamps may be slid along the bracket to fit the distance between the headrest poles of the headrest that differs per type of automobile.

The mount body may have a connected part with a different height, allowing the user to select the height of the monitor to fit his view angle.

The covers may cover the headrest fixing part to contribute to an organized and tidy look of the monitor mount.

While the inventive concept has been shown and described with reference to exemplary embodiments thereof, it will be apparent to those of ordinary skill in the art that various changes in form and detail may be made thereto without departing from the spirit and scope of the inventive concept as defined by the following claims.

What is claimed:

1. A monitor mount, comprising:
a headrest fixing part comprising a clamp holding a headrest pole, and a bracket to which the clamp is slidably coupled; and
a mount body coupled with the headrest fixing part, wherein a monitor is coupled with the mount body to be tilted with respect to the mount body.

2. The monitor mount of claim 1, wherein the clamp includes a sliding part slidably coupled to a guide rail formed in the bracket and a covering part pivotally coupled to the sliding part.

3. The monitor mount of claim 1, wherein the sliding part and the covering part, respectively, have curved parts, the headrest pole positioned between the curved parts.

4. The monitor mount of claim 2, wherein the sliding part and the covering part are fastened to each other by a bolt, with the headrest pole positioned therebetween.

5. The monitor mount of claim 1, further comprising a pair of covers coupled to each other to cover the headrest fixing part.

6. The monitor mount of claim 1, further comprising a spacer provided the headrest fixing part and the mount body.

7. The monitor mount of claim 1, wherein a part of the mount body which is coupled with the headrest fixing part is positioned at one of various heights.

8. The monitor mount of claim 1, wherein the monitor is tilted by way of a tilting mechanism with respect to the mount body.

9. The monitor mount of claim wherein the tilting mechanism comprises:
a shall attached to the mount body;
a cam washer attached to an end portion of the shaft and having a cut; and
a stand connected with the cam washer through a hole of the stand and having a claw at a position corresponding to the cut, wherein a width of the claw is smaller than a width of the cut, and wherein the stand is attached to the monitor.

10. The monitor mount of claim 9, further comprising:
a nut coupled to the end portion of the shaft; and
a coil spring between the nut and the stand.

11. The monitor mount of claim 10, wherein one of the cam washer and the stark includes at least one hole, and the other of the cam washer and the stand includes at least one protrusion at a position fitted into the at least one hole.
